(19) United States
(12) Patent Application Publication
(10) Pub. No.: US 2018/0313061 A1
(43) Pub. Date: Nov. 1, 2018

(54) CONTROL SYSTEM USING FUZZY LOGIC TO DISPLAY MACHINE PRODUCTIVITY DATA

(71) Applicant: Caterpillar Inc., Peoria, IL (US)

(72) Inventors: Zhijun Cai, Dunlap, IL (US); Bradley K. Bomer, Pekin, IL (US); Nolan Graves, Peoria, IL (US); Allen DeClerk, Princeton, IL (US)

(73) Assignee: Caterpillar Inc., Peoria, IL (US)

(21) Appl. No.: 15/497,475

(22) Filed: Apr. 26, 2017

(51) Int. Cl. E02F 9/26; E02F 3/32; G06N 7/02; G07C 3/08

(52) U.S. Cl. CPC E02F 9/26; G07C 3/08; G06N 7/02; E02F 3/32

(57) ABSTRACT

A control system for a machine includes multiple sensors coupled to multiple parts on the machine. The multiple sensors generate data indicative of motion of the multiple parts of the machine. The control system includes a controller in communication with the multiple sensors. The controller receives the data indicative of motion of the multiple parts of the machine from the multiple sensors. The controller determines a segment of the work cycle being currently performed by the machine based on the data received by the multiple sensors, and multiple membership functions. The controller generates productivity data of the machine based on the determined segment of the work cycle. Furthermore, the controller displays the productivity data of the machine on a display system.

### TECHNICAL FIELD

The present disclosure relates to a control system for a machine. More particularly, the present disclosure relates to a control system using fuzzy logic for displaying productivity data of the machine on a display system.

### BACKGROUND

Work machines such as excavators, backhoes, front shovels, and the like are used for excavation work. These excavating machines have work implements which consist of boom, stick and bucket linkages. The boom is pivotally attached to the excavating machine at one end, and to its other end is pivotally attached a stick. The bucket is pivotally attached to the free end of the stick. Each work implement linkage is controllably actuated by at least one hydraulic cylinder for movement in a vertical plane. An operator typically manipulates the work implement to perform a sequence of distinct functions which constitute a complete excavation work cycle.

In a typical work cycle, the operator first positions the work implement at a dig location, and lowers the work implement downward until the bucket penetrates the soil. Then the operator executes a digging stroke which brings the bucket toward the excavating machine. The operator subsequently curls the bucket to capture the soil. To dump the captured load the operator raises the work implement, swings it transversely to a specified dump location, and releases the soil by extending the stick and uncurling the bucket. The work implement is then returned to the trench location to begin the work cycle again. In the following discussion, the above operations are referred to respectively as digging, swing loaded, dumping, and swing empty.

In order to facilitate productive control of an excavation machine and quality data gathering associated with performance tracking of the machine, it can be important to accurately detect and/or classify which segment of the work cycle is currently being performed (i.e., detect when one segment has started, which segment it is, and when it ends). There are various control systems to ascertain the current work cycle segment being performed. One of the control systems is described by U.S. Pat. No. 5,999,872 (hereinafter referred to as '872 patent). The '872 patent discloses a control apparatus for a hydraulic excavator capable of carrying out precise operations according to various kinds of classifications of works without requiring switching operations by an operator and management according to work records. The control apparatus includes a classification of work discriminating section for recognizing a classification of work being carried out by the hydraulic excavator on the basis of data detected by sensors for detecting an operating amount of a lever for a boom and the like. The sensors may be pressure sensors provided in specific levers that an operator pulls. The pressure sensors are generally expensive. Thus, an improved control system for determining the work cycle of the machine and subsequently controlling the machine is required.

### SUMMARY

In an aspect of the present disclosure, a control system for a machine includes multiple sensors coupled to multiple parts on the machine. The multiple sensors generate data indicative of motion of the multiple parts. The control system further includes a controller in communication with the multiple sensors. The controller receives the data indicative of motion of the multiple parts of the machine from the multiple sensors. The controller determines a segment of a work cycle being currently performed by the machine based on the data received by the multiple sensors, multiple membership functions, and multiple rules associated with the multiple membership functions. The controller generates productivity data of the machine based on the determined segment of the work cycle. Furthermore, the controller displays the productivity data of the machine on a display system.

In another aspect of the present disclosure, a control system for retrofitting to a machine is provided. The control system includes a controller in communication with multiple sensors coupled to multiple parts of the machine. The controller receives data indicative of motion of the multiple parts of the machine from the multiple sensors. The controller determines a segment of a work cycle being currently performed by the machine based on the data received by the multiple sensors, multiple membership functions, and multiple rules associated with the multiple membership functions. The controller generates productivity data of the machine based on the determined segment of the work cycle. Furthermore, the controller displays the productivity data of the machine on a display system.

In yet another aspect of the present disclosure, a machine includes multiple sensors coupled to multiple parts on the machine. The multiple sensors generate data indicative of motion of the multiple parts. The machine includes a display system. The machine further includes a controller in communication with the multiple sensors, and the display system. The controller receives data indicative of the motion of the multiple parts of the machine from the multiple sensors. The controller determines a segment of a work cycle being currently performed by the machine based on the data received by the multiple sensors, multiple membership functions, and multiple rules associated with the multiple membership functions. The controller generates productivity data of the machine based on the determined segment of the work cycle. Furthermore, the controller displays the productivity data of the machine on the display system of the machine.

### BRIEF DESCRIPTION OF DRAWINGS

FIG. 1 illustrates an exemplary machine, according to an aspect of the present disclosure;

FIG. 2 illustrates a block diagram for a control system for the machine, according to an aspect of the present disclosure;

FIG. 3 illustrates a boom angle membership function, according to an aspect of the present disclosure;

FIG. 4 illustrates a boom movement membership function, according to an aspect of the present disclosure;

FIG. 5 illustrates a stick angle membership function, according to an aspect of the present disclosure;

FIG. 6 illustrates a stick movement membership function, according to an aspect of the present disclosure;

FIG. 7 illustrates a body swing membership function, according to an aspect of the present disclosure;

FIG. 8 illustrates a control system for the machine, according to another aspect of the present disclosure; and

FIG. 9 illustrates a flow chat for a method to control the machine, according to an aspect of the present disclosure.

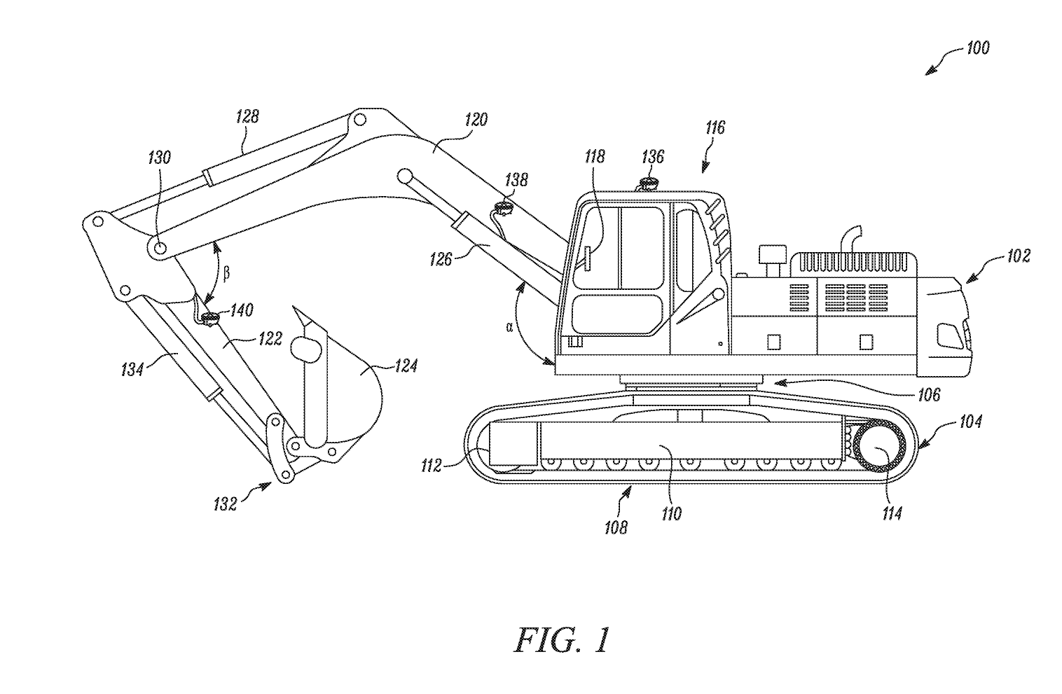

### DETAILED DESCRIPTION

Wherever possible, the same reference numbers will be used throughout the drawings to refer to same or like parts. FIG. 1 shows an exemplary machine 100 in accordance with an embodiment of the present disclosure. Although, the machine 100 is illustrated as a hydraulic excavator, the machine 100 may be any other type of a work machine as well which may perform a repetitive work cycle of operations associated with industries such as mining, construction, farming, transportation, landscaping, or the like. Examples of such machines may include wheel loader, hydraulic shovel, dozer, dump truck etc. While the following detailed description describes an exemplary aspect in connection with the hydraulic excavator, it should be appreciated that the description applies equally to the use of the present disclosure in other machines as well.

The machine 100 includes a body 102 mounted atop an undercarriage assembly 104 such that the body 102 may rotate relative to the undercarriage assembly 104. The body 102 may be coupled to the undercarriage assembly 104 through a linkage mechanism 106 which may allow all possible types of relative movements which may be required between the body 102 and the undercarriage assembly 104. The undercarriage assembly 104 includes a track system 108 positioned on each of two opposing sides of the undercarriage assembly 104. The undercarriage assembly 104 further includes a track roller frame 110 coupled with the undercarriage assembly 104 and a number of rotatable track-engaging elements, such as an idler 112 and a sprocket 114. The idler 112 is configured to rotate passively during operation of the undercarriage assembly 104. The sprocket 114 is configured to drive the undercarriage assembly 104.

The machine 100 further includes an operator station 116 mounted on the body 102 to accommodate an operator for operating the machine 100. The operator station 116 may include various control systems for controlling the machine 100. The operator station 116 includes a display system 118 for displaying various operational parameters of the machine 100. The display system 118 may be used to display various types of information for reference of the operator. The display system 118 may include a display screen to operate the display system 118. The display system 118 may also include a user interface such as a button, a joystick etc. to operate the display screen. The display screen may be any type of a display screen such as a digital display, a touchscreen display etc.

The machine 100 further includes a boom 120, a stick 122 and a bucket 124. The boom 120 is coupled to the body 102. The boom 120 is controlled through boom cylinders 126. The boom cylinders 126 are coupled to the body 102 at one end and the boom 120 at another end. The boom cylinders 126 are retractable and may be actuated by hydraulic means. The boom 120 may be coupled to the body 102 through a boom linkage (not shown). The boom 120 may be rotated about the boom linkage through actuation of the boom cylinders 126. A boom linkage angle α is defined as an angle included between the boom 120 and the body 102 at the boom linkage. The boom linkage angle α varies with the rotation of the boom 120 relative to the body 102.

The stick 122 is coupled to the boom 120 and may be actuated through a stick cylinder 128. The stick cylinder 128 may be actuated by hydraulic means. The stick 122 is coupled to the boom 120 through a stick linkage 130. The stick 122 may rotate about the stick linkage 130 through actuation of the stick cylinder 128. A stick angle β is defined as an angle included between the stick 122 and the boom 120 at the stick linkage 130. The stick angle β varies with the rotation of the stick 122 relative to the boom 120. The bucket 124 is coupled to the stick 122 through a coupler mechanism 132. The bucket 124 may rotate about the coupler mechanism 132 through actuation of a bucket cylinder 134. The operator station 116 may include means to control the movements of the boom 120, the stick 122 and the bucket 124 from inside the operator station 116.

The machine 100 includes multiple sensors coupled to multiple parts of the machine 100. The machine 100 includes a body swing sensor 136 coupled to the body 102 of the machine 100. The body swing sensor 136 generates data indicative of movement of the body 102. The body swing sensor 136 may sense type of movement being performed by the body 102 as well as a direction of movement of the body 102. In an embodiment, the body swing sensor 136 generates data indicative of a body swing status. The machine 100 includes a boom sensor 138 coupled to the boom 120 of the machine 100. The boom sensor 138 generates data indicative of movement of the boom 120. The boom sensor 138 may sense type of movement being performed by the boom 120 as well as a direction of movement of the boom 120. In an embodiment, the boom sensor 138 generates data indicative of the boom linkage angle α. The boom sensor 138 also generates data indicative of angular velocity of the boom 120.

The machine 100 further includes a stick angle sensor 140 coupled to the stick 122 of the machine 100. The stick angle sensor 140 generates data indicative of movement of the stick 122. The stick angle sensor 140 may sense type of movement being performed by the stick 122 as well as a direction of movement of the stick 122. In an embodiment, the stick angle sensor 140 generates data indicative of the stick angle (3. The stick angle sensor 140 also generates data indicative of angular velocity of the stick 122. The body swing sensor 136, the boom sensor 138, and the stick angle sensor 140 may be any type of sensors which may generate data indicative of the movement of respective parts of the machine 100 to which the sensors are coupled. In an exemplary embodiment, the body swing sensor 136, the boom sensor 138, and the stick angle sensor 140 are Inertial Measurement Units (IMU). Other exemplary types of sensors may include an accelerometer, a gyroscope etc.

The machine 100 may perform a repetitive work cycle in order to carry out a task at a worksite. A typical work cycle may include a digging segment, a swing loaded segment, a dumping segment, and a swing empty segment. The operator may control various part of the machine 100 for example, the body 102, the boom 120, the stick 122, and the bucket 124 to perform these segments. It may be advantageous to determine a segment of the work cycle being currently performed by the machine 100 in order to control the machine 100 in an efficient manner.

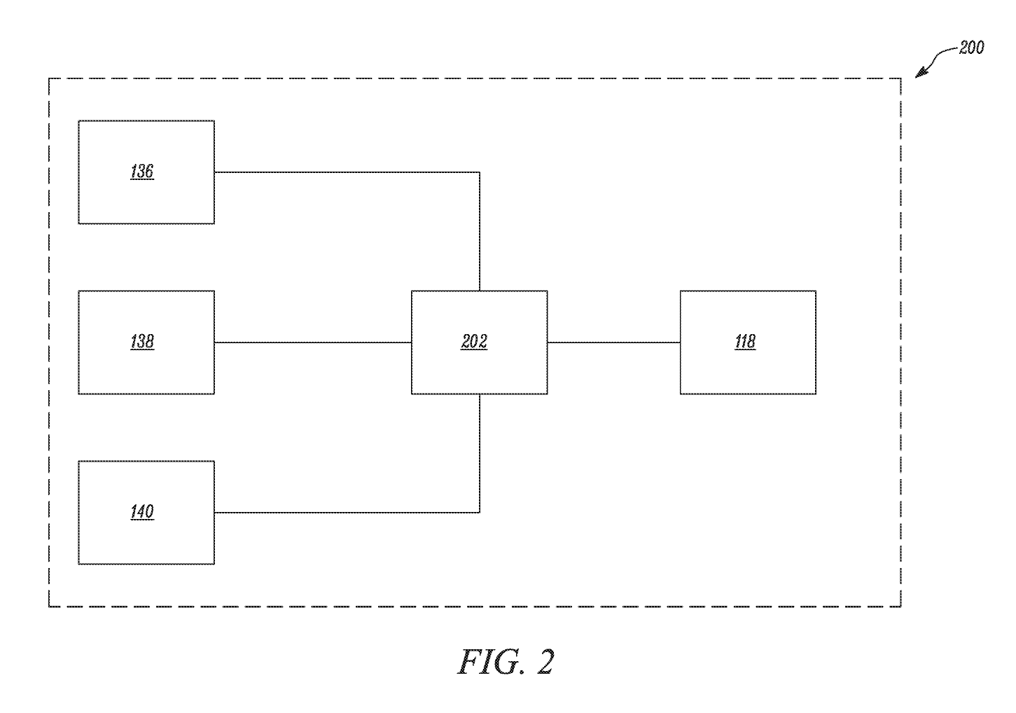

FIG. 2 illustrates a control system 200 for the machine 100 which may determine the segment of the work cycle being currently performed by the machine 100. The control system 200 includes the body swing sensor 136, the boom sensor 138, and the stick angle sensor 140. The control system 200 includes a controller 202 in communication with the body swing sensor 136, the boom sensor 138, and the stick angle sensor 140. The controller 202 receives the data indicative of the body swing status from the body swing sensor 136. The controller 202 receives the data indicative of the boom linkage angle α, and the boom movement status from the boom sensor 138. Furthermore, the controller 202 receives data indicative of the stick angle (3, and the stick movement status from the stick angle sensor 140.

The controller 202 may use fuzzy logic to determine the segment of work cycle being currently performed by the machine 100. The controller 202 may include an associated memory which may store multiple membership functions between various ranges of values of data indicative of type and status of movement of the body 102, the boom 120, and the stick 122 of the machine 100. The membership functions map the data received by the controller 202 from the body swing sensor 136, the boom sensor 138, and the stick angle sensor 140 to linguistic values.

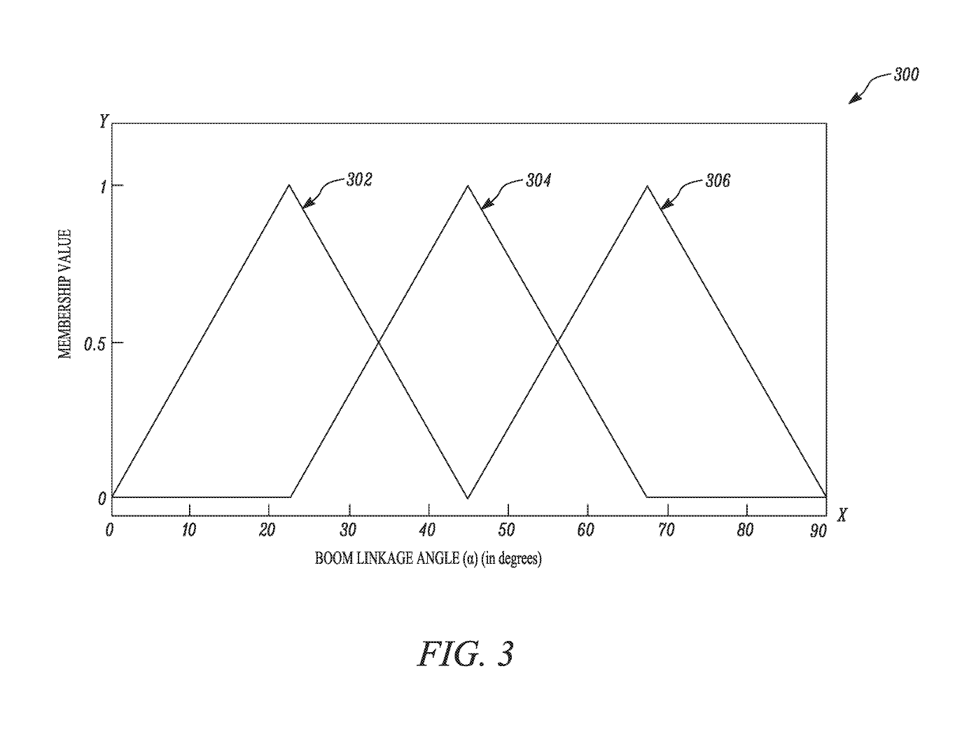

Linguistic values may generally be defined as an output value of the membership function for a range of values of a variable which may be measured by a sensor. For example, the membership function may output linguistic values of low, medium, or high for values of the boom angular velocity measured by the boom sensor 138 in a range of 0 to 0.5 radians per second. The membership function may be defined to output linguistic values for a range of values of a variable as required. For example, the membership function may output a linguistic value of low for the values of the boom angular velocity in a range of 0 to 0.10, medium for a range of 0.11 to 0.40, and high for a range of 0.41 to 0.5. However, the values provided here are merely exemplary, and actual definitions of the membership functions may vary as per the application requirements. FIGS. 3-7 illustrate membership functions for the ranges of values of data generated by the body swing sensor 136, the boom sensor 138, and the stick angle sensor 140.

FIG. 3 graphically illustrates a boom angle membership function 300. In the illustrated embodiment, the boom linkage angle α may vary in a range of 0 to 90 degrees. Limits of the boom linkage angle α may be defined in any other range as well based on the type of the machine 100, as well as the application requirements. X-axis represents values of the boom linkage angle α in degrees and Y-axis represents a membership value. The membership value varies between 0 and 1. The boom angle membership function 300 defines the linguistic values of the boom linkage angle α as a first boom angle 302, a second boom angle 304, and a third boom angle 306. In an embodiment, the first boom angle 302 can be lower than the second boom angle 304, and the third boom angle 306. Furthermore, the second boom angle 304 can be lower than the third boom angle 306.

In an exemplary embodiment, the boom angle membership function 300 may define the first boom angle 302, second boom angle 304 and the third boom angle 306 as Low, Middle, and High. Therefore, the values of the boom linkage angle α having a range between 0 to 90 degrees may be correspondingly translated to linguistic values as the first boom angle 302, the second boom angle 304, and the third boom angle 306. The first boom angle 302, the second boom angle 304, and the third boom angle 306 each have a membership function value between 0 and 1 for the values of boom angle α having a range between 0 to 90 degrees indicating likelihood of the value of boom angle α falling under the linguistic value. It should be contemplated that any number of linguistic values may be defined. For example, a membership function may divide the range of 0 to 90 degrees in 5 linguistic values, for example, very low, low, middle, high, and very high.

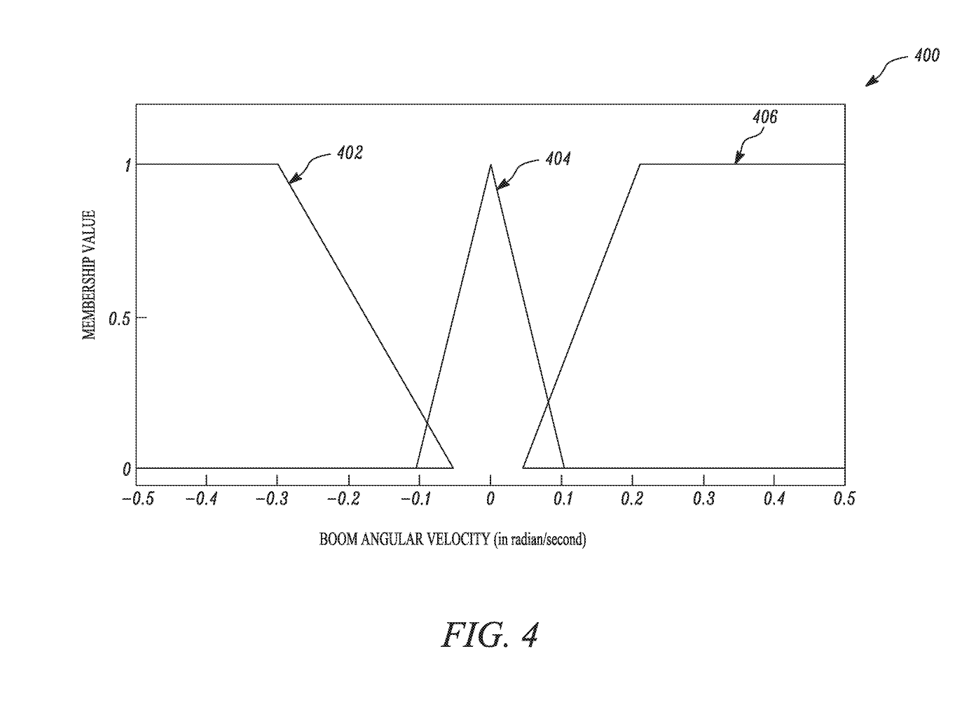

FIG. 4 graphically illustrates a boom movement membership function 400. The boom 120 may either move in an upwards direction, or a downwards direction or not move at all. X-axis represents the angular velocity of the boom 120 measured by the boom sensor 138 in radian per second, and Y-axis represents membership values of a first boom movement status 402, a second boom movement status 404, and a third boom movement status 406. In an embodiment, the first boom movement status 402 is the upwards movement of the boom 120, the second boom movement status 404 is no movement of the boom 120, and the third boom movement status 406 is the downward movement of the boom 120. Thus, the boom movement membership function 400 linguistically translates the values of the angular velocity of the boom 120 to upward movement, no movement, and downward movement of the boom 120.

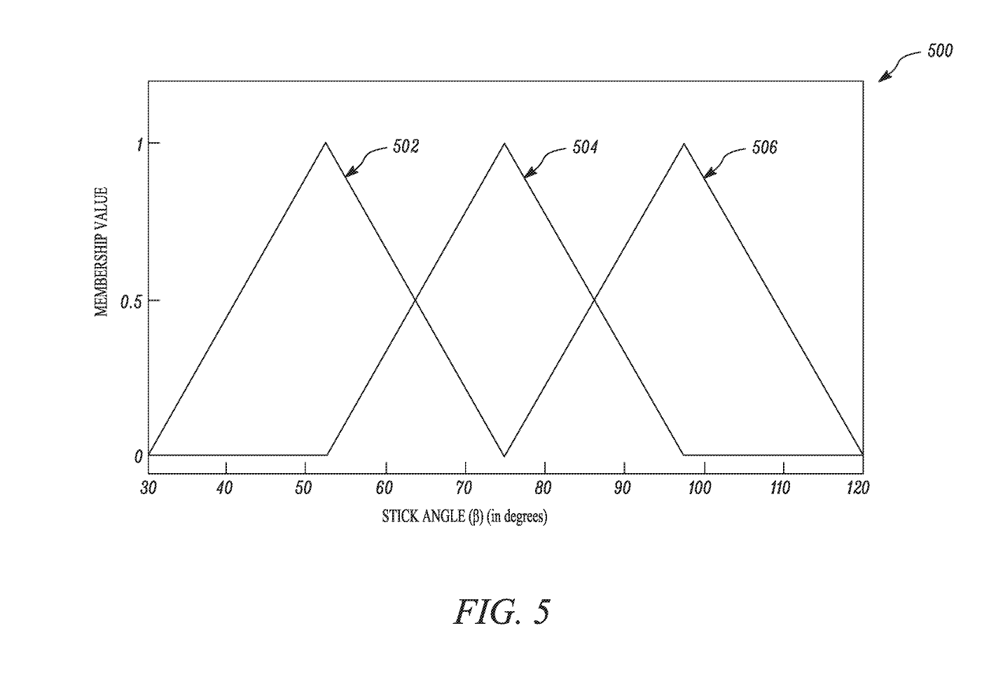

FIG. 5 graphically illustrates a stick angle membership function 500. In the illustrated embodiment, the stick angle β may vary in a range of 0 to 120 degrees. Limits of the stick angle β may be defined in any other range as well based on the type of the machine 100, as well as the application requirements. X-axis represents values of the stick angle β and Y-axis represents a membership value. The membership value varies between 0 and 1. The stick angle membership function 500 defines the linguistic values of the stick angle β as a first stick angle 502, a second stick angle 504, and a third stick angle 506. In an embodiment, the first stick angle 502 is lower than the second stick angle 504 and the third stick angle 506. Furthermore, the second stick angle 504 is lower than the third stick angle 506.

In an exemplary embodiment, the stick angle membership function 500 may linguistically define the first, second and third stick angles as In, Middle, and Out. Therefore, the values of the stick angle β having a range between 0 to 120 degrees may be correspondingly translated to linguistic values as the first stick angle 502, the second stick angle 504, and the third stick angle 506. The first stick angle 502, the second stick angle 504, and the third stick angle 506 each have a membership function value between 0 and 1 for the stick angle β having a range of values between 0 to 120 degrees indicating likelihood of the value of the stick angle β falling under the linguistic value. It should be contemplated that any number of linguistic values may be defined. For example, a membership function may divide the range of values of stick angle β between 0 to 120 degrees in 5 linguistic values, for example, Very In, In, Middle, Out, and Very Out.

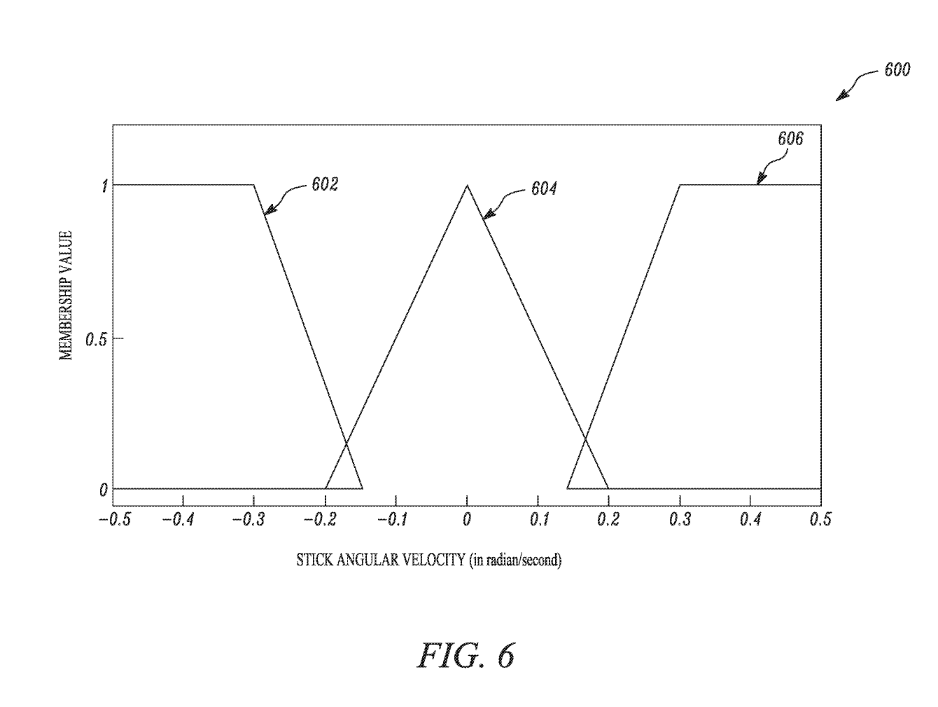

FIG. 6 graphically illustrates a stick movement membership function 600. The stick 122 may either move in an inwards direction, an outwards direction or not move at all, relative to the boom 120. X-axis represents angular velocity of the stick 122 in radian per second, and Y-axis represents membership values of a first stick movement status 602, a second stick movement status 604, and a third stick movement status 606. In an embodiment, the first stick movement status 602 is the inwards movement of the stick 122, the second stick movement status 604 is no movement of the stick 122, and the third stick movement status 606 is the outwards movement of the stick 122, relative to the boom 120. The first stick movement status 602, the second stick movement status 604, and the third stick movement status 606 linguistically translate the values of the angular velocity of the stick 122 to inwards movement, no movement, and upwards movement of the stick 122, relative to the boom 120.

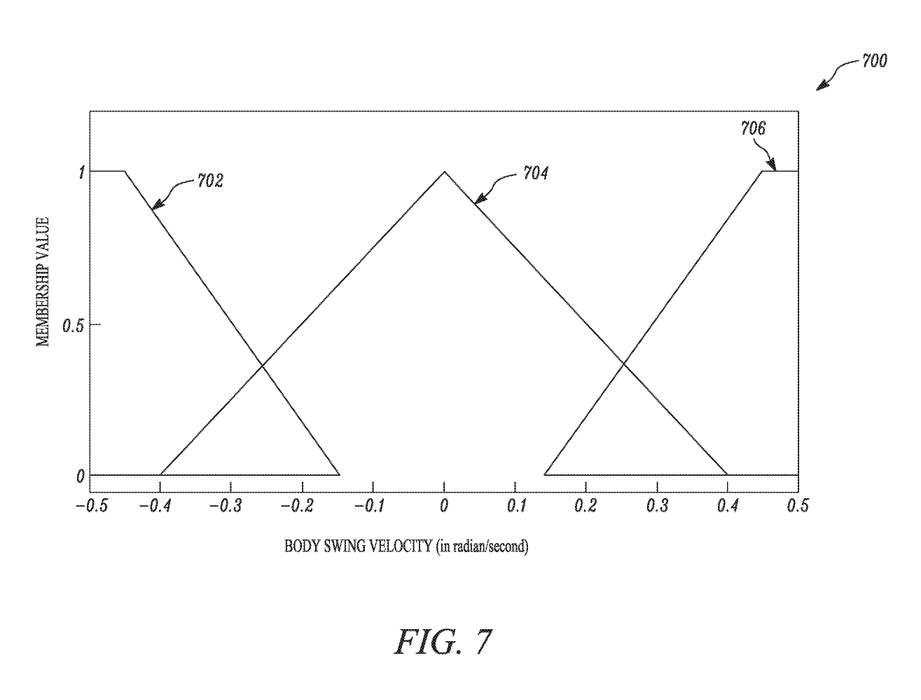

FIG. 7 graphically illustrates a body swing membership function 700. The body 102 may rotate or swing relative to the undercarriage assembly 104 towards a left side, a right side, or not swing at all. The left and right sides are to be assumed with respect to a forward travelling direction of the machine 100. X-axis represents swing velocity of the body 102 in radian per second, and Y-axis represents membership values of a first body swing status 702, a second body swing status 704, and a third body swing status 706. In an embodiment, the first body swing status 702 is the left side swing of the body 102, the second body swing status 704 is no swing of the body 102, and the third body swing status 706 is the right swing of the body 102. The first body swing status 702, the second body swing status 704, and third body swing status 706 linguistically translate the values of the angular velocity of the body 102 to left swing, no swing, and right swing of the body 102 relative to the undercarriage assembly 104.

With combined reference to FIGS. 2-7, the controller 202 receives the data indicative of the movement of the body 102, the boom 120, and the stick 122 from the body swing sensor 136, the boom sensor 138, and the stick angle sensor 140 respectively, and determines corresponding linguistic values of the movement variables. The controller 202 may then identify the segment of the work cycle being currently performed by the machine 100 based on the received data as well as the membership functions. The controller 202 may store in the associated memory multiple rules defining relationships between the various movement variables defining the movement of the multiple parts of the machine 100. The controller 202 may determine the segment of the work cycle being currently performed by the machine 100 based on the rules.

Examples of such rules may include rules for the digging segment, the swing loaded segment, the dumping segment, and the swing empty segment. In an exemplary embodiment, the rule for digging segment may be defined between the boom linkage angle α, the boom movement status, the stick angle β, the stick movement status, and the body swing status. The controller 202 may determine the machine 100 to be performing the digging segment of the work cycle when the boom linkage angle α is the first boom angle 302, the boom movement status is the first boom movement status 402, the stick angle β is the first stick angle 502, the stick movement status is the first stick movement status 602, and the body swing status is the first body swing status 702.

The controller 202 may determine the machine 100 to be performing the swing loaded segment of the work cycle when the boom linkage angle α is the second boom angle 304, the boom movement status is the second boom movement status 404, the stick angle β is the second stick angle 504, the stick movement status is the second stick movement status 604, and the body swing status is the second body swing status 704. The controller 202 may determine the machine 100 to be performing the dumping segment when the boom linkage angle α is the third boom angle 306, the boom movement status is the third boom movement status 406, the stick angle β is the third stick angle 506, the stick movement status is the first stick movement status 602, and the body swing status is the first body swing status 702.

Similarly, the controller 202 may determine the machine 100 to be performing the swing empty segment of the work cycle when the boom linkage angle α is the first boom angle 302, the boom movement status is the first boom movement status 402, the stick angle β is the second stick angle 504, the stick movement status is the second stick movement status 604, and the body swing status is the third body swing status 706. It should be contemplated that there may be any number of rules defined for each of the segment of the work cycle based on the type of the machine 100 as well as the application requirements. Furthermore, although the exemplary rules are defined between the boom linkage angle α, the boom movement status, the stick angle β, the stick movement status, and the body swing status, it should be contemplated that any number of such parameters may be used to define the rules. The present disclosure, in any manner, is not limited to the number of parameters being used, or the specific values of the parameters define for the exemplary rules.

When the machine 100 is performing a work cycle, the machine 100 sequentially performs the steps of the work cycle, for example, the digging segment, the swing loaded segment, the dumping segment, and the swing loaded segment. Sometimes, it may be difficult to define exact boundaries of the segments of the work cycle. Typically, there is a transition state between the two segments. The controller 202 may, in such cases, match the data corresponding to the type and movement of the various parts of the machine 100, and apply the rules to identify the segment of work cycle which may be defined as closest to the current operating conditions of the machine 100.

For example, the transition of the machine 100 between the digging segment and the swing loaded segment may appear to the controller 202 as digging at first. The controller 202 may then identify that the machine 100 is slowly starting to look like swinging. The controller 202 may then identify that the machine 100 appears more like swinging as compared to digging. Afterwards, the controller 202 may ascertain that the machine 100 is surely swinging. Thus, the controller 202 may define switching between two segments of the work cycle in transitioning phases as well instead of discretely defining the segments of the work cycle by application of fuzzy logic.

Once the segment of the work cycle being performed currently is determined, the controller 202 may use this information to display productivity data of the machine 100 on the display system 118. The productivity data may include, for example, count of various segments of work cycles performed by the machine 100, time spent by the machine 100 performing each segment of the work cycle, etc. The productivity data may be displayed in any suitable data displaying methods such as tables, bar charts, pie charts etc., which may be suitable as per application requirements. The controller 202 may also display the productivity data of the machine 100 on an off-board or remote location such as a back-office. The productivity data may also be displayed on tablets or computers or mobile phones etc. of personnel who may be managing the work site. It should be understood that the present disclosure is not limited by the location of displaying the productivity data in any manner.

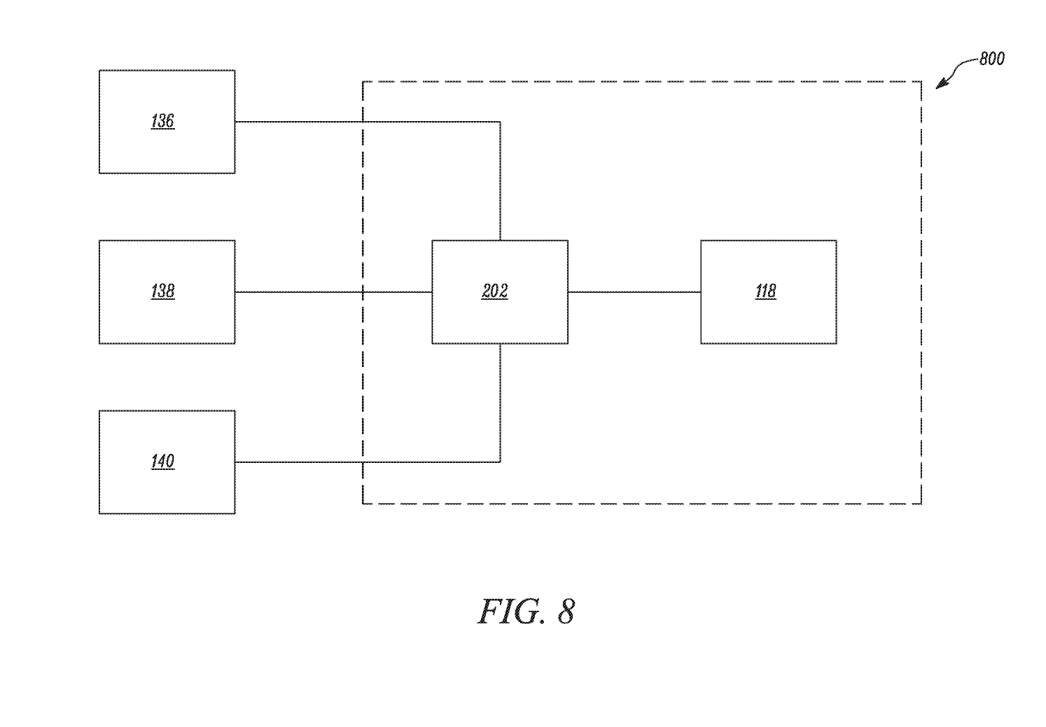

FIG. 8 schematically illustrates another embodiment of the present disclosure. A control system 800 for retrofitting to the machine 100 is provided. In this embodiment, the body swing sensor 136, the boom sensor 138, and the stick angle sensor 140 are already provided on the machine 100. The control system 800 includes the controller 202 which may include means to receive data from the body swing sensor 136, the boom sensor 138, and the stick angle sensor 140. Furthermore, the control system 800 includes the display system 118 in communication with the controller 202. The control system 800 functions in a similar manner as the control system 200 to determine the segment of the work cycle being currently performed by the machine 100, and displays the productivity data on the display system 118.

### INDUSTRIAL APPLICABILITY

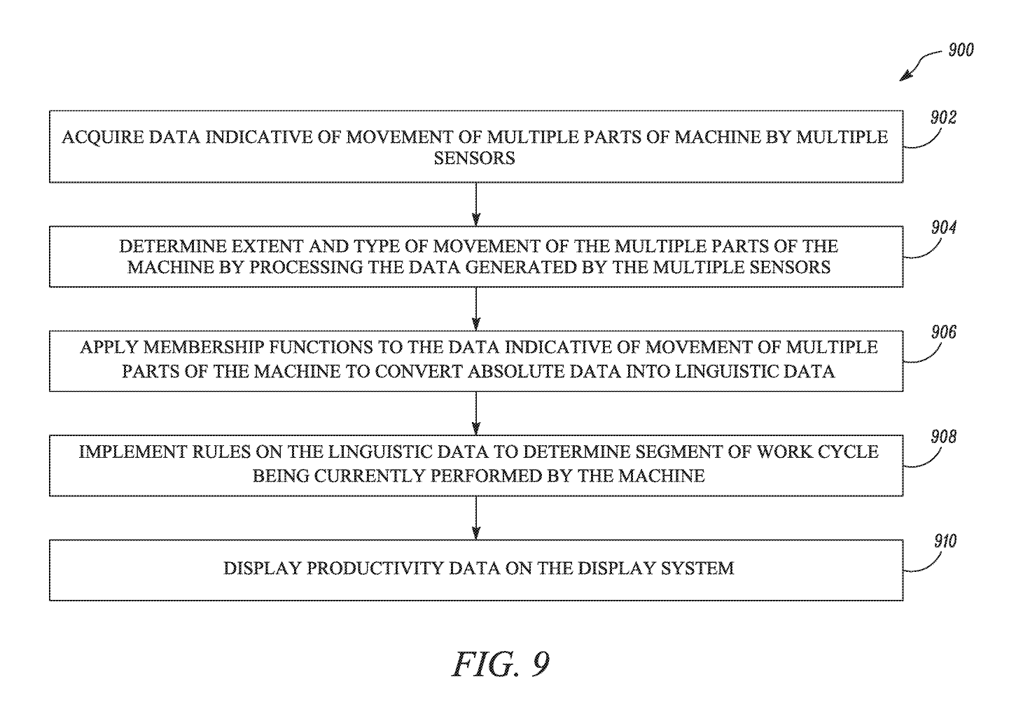

The present disclosure provides an improved means of determining the segment of the work cycle being currently performed by the machine 100, and displays productivity data of the machine 100 on the display system 118 of the machine 100. FIG. 9 illustrates a method 900 of determining the segment of the work cycle being currently performed by the machine 100 with help of a flow chart. At block 902, the data indicative of the movement of various parts of the machine 100 is acquired by the multiple sensors. Specifically, the body swing sensor 136 generates data indicative of the movement of the body 102, the boom sensor 138 generates data indicative of the movement of the boom 120, and the stick angle sensor 140 generates data indicative of the movement of the stick 122.

At block 904, the data generated by the multiple sensors is processed by the controller 202 to determine type of movement of the multiple parts of the machine 100 to which the multiple sensors are attached. Specifically, the data generated by the body swing sensor 136 is processed to determine the swing velocity of the body 102. The data generated by the boom sensor 138 is processed to determine the boom linkage angle α, and the angular velocity of the boom 120. Furthermore, the data generated by the stick angle sensor 140 is processed to determine the stick angle β, and the angular velocity of the stick 122.

At block 906, respective membership functions are applied to the swing velocity of the body 102 as measured by the body swing sensor 136, boom linkage angle α and angular velocity of the boom 120 as measured by the boom sensor 138, stick angle β and the angular velocity of the stick 122 as measured by the stick angle sensor 140. The membership functions translate the data generated by the sensors to the corresponding linguistic values. At block 908, rules are implemented on the linguistic values to determine the segment of work cycle being currently performed by the machine 100. The controller 202 may store rules for each segment of the work cycle in the associated memory. The controller 202 may generate productivity data of the machine 100 based on the determined segment of the work cycle. At block 910, the controller 202 displays the productivity data of the machine 100 on the display system 118. The controller 202 may also display the productivity data on an off-board location as well such as a back-office.

For a lot of machine applications, transitions between two consecutive segments of work cycle may not be discretely defined. For example, the operator of the machine 100 starts swinging as soon as the digging is finished. Therefore, it may be difficult to precisely define end of digging or start of swinging. The end of digging or the start of swinging may be defined when the body 102 of the machine 100 starts to rotate, or when the boom 120 starts to rise, or when the bucket 124 stops curling. These three exemplary events may or may not coincide with each other, therefore making it difficult to precisely define the end of digging or start of swinging.

The present disclosure eliminates the need to discretely define the start or end of a segment of the work cycle as the controller 202 may follow the transition between the two segments and identify the best fit pre-defined segment of the work cycle based on the type and extent of movement of various parts of the machine 100. For example, the controller 202 receives the data generated by the body swing sensor 136, the boom sensor 138, and the stick angle sensor 140 and converts into the linguistic values. Various combinations of the linguistic values defined by the rules stored in the memory of the controller 202 may indicate the segment of the work cycle being performed by the machine 100.

Furthermore, as the controller 202 uses fuzzy logic and processes linguistic values output by the membership functions instead of the data generated by the body sensor 136, the boom sensor 138, and the stick angle sensor 140, the controller 202 may more precisely determine the segment of the work cycle being performed even in the transient period when the machine 100 is shifting from one segment of the work cycle to another. Thus, the controller 202 may accurately determine the segment of work cycle being currently performed by the machine 100 at all times, and subsequently provide accurate productivity data so that the machine 100 may be controlled in a more efficient and productive manner.

The present disclosure further provides an advantage of determining the work cycle being currently performed by the machine 100 through fuzzy logic application instead of data acquired by sensors. Sometimes, two different operations being performed by the machine 100 may appear identical to the controller 202, if the controller 202 only takes the sensor data into account. For example, the controller 202 may not be able to differentiate between a trenching operation and a truck loading operation of the machine 100, if the controller 202 analyzes the motion of the boom 120, the stick 124, and the bucket 124 based on the data derived from the sensors. This may provide inaccurate information about the segment of the work cycle being currently performed by the machine 100.

Typically, the truck loading operation may involve raising the bucket 124 to a higher level as compared to the trenching operation. Furthermore, the truck loading operation may also involve swinging the body 102 from a dig location to a dump location. The controller 202 as described in the present disclosure, translates the data generated by the sensors to linguistic values, and then applies rules on the linguistic values to determine the work cycle being currently performed by the machine 100. Accordingly, the controller 202 may take into account the type of movements of different parts of the machine 100 as well as combination of movements of two or more parts of the machine 100 to determine the segment of the work cycle being currently performed by the machine 100. Thus, the controller 202 may more precisely differentiate the trenching and truck loading operations of the machine 100 based on fuzzy logic application.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A control system comprising:
a plurality of sensors coupled to a plurality of parts on a machine, the plurality of sensors configured to generate data indicative of motion of the plurality of parts; and
a controller communicably coupled to the plurality of sensors, the controller configured to:
receive the data indicative of motion of the plurality of parts of the machine from the plurality of sensors;
determine a segment of a work cycle being currently performed by the machine based on the data received by the plurality of sensors, a plurality of membership functions, and a plurality of rules associated with the plurality of membership functions;
generate productivity data of the machine based on the determined segment of the work cycle; and
display the productivity data of the machine on a display system.

2. The control system of claim 1, wherein the plurality of sensors comprise Inertial Measuring Unit (IMU) sensors.

3. The control system of claim 1, wherein the machine comprises a body, a boom, a stick, and a bucket.

4. The control system of claim 3, wherein the plurality of sensors include:
a body swing sensor coupled to the body of the machine, the body swing sensor configured to generate data indicative of a body swing status;
a boom sensor coupled to the boom of the machine, the boom sensor configured to generate data indicative of a boom linkage angle, and a boom movement status; and
a stick angle sensor coupled to the stick of the machine, the stick angle sensor configured to generate data indicative of a stick angle, and a stick movement status.

5. The control system of claim 4, wherein the plurality of rules associated with the plurality of membership functions includes rules for at least a digging segment, a swing loaded segment, a dumping segment, and a swing empty segment.

6. The control system of claim 5, wherein the rule for the digging segment is defined as having the boom linkage angle as a first boom angle, the boom movement status as a first boom movement status, the stick angle as a first stick angle, the stick movement status as a first stick movement status, and the body swing status as a first body swing status.

7. The control system of claim 5, wherein the rule for the swing loaded segment is defined as having the boom linkage angle as a second boom angle, the boom movement status as a second boom movement status, the stick angle as a second stick angle, the stick movement status as a second stick movement status, and the body swing status as a second body swing status.

8. The control system of claim 5, wherein the rule for the dumping segment is defined as having the boom linkage angle as a third boom angle, the boom movement status as a third boom movement status, the stick angle as a third stick angle, the stick movement status as the first stick movement status, and the body swing status as the first body swing status.

9. The control system of claim 5, wherein the rule for the swing empty segment is defined as having the boom linkage angle as the first boom angle, the boom movement status as the first boom movement status, the stick angle as the second stick angle, the stick movement status as the second stick movement status, and the body swing status as the first body swing status.

10. A control system for retrofitting to a machine, the control system comprising:
a controller communicably coupled to a plurality of sensors disposed on a plurality of parts on the machine, the controller configured to:
receive data indicative of motion of the plurality of parts of the machine from the plurality of sensors;
determine a segment of a work cycle being currently performed by the machine based on the data received by the plurality of sensors, a plurality of membership functions, and a plurality of rules associated with the plurality of membership functions;
generate productivity data of the machine based on the determined segment of the work cycle segment; and
display the productivity data of the machine on a display system.

11. The control system of claim 10, wherein the plurality of sensors comprise Inertial Measuring Unit (IMU) sensors.

12. The control system of claim 10, wherein the machine comprises a body, a boom, a stick, and a bucket.

13. The control system of claim 12, wherein the plurality of sensors include:
a body swing sensor coupled to the body of the machine, the body swing sensor configured to generate data indicative of a body swing status;
a boom sensor coupled to the boom of the machine, the boom sensor configured to generate data indicative of a boom linkage angle, and a boom movement status; and
a stick angle sensor coupled to the stick of the machine, the stick angle sensor configured to generate data indicative of a stick angle, and a stick movement status.

14. The control system of claim 12, wherein the plurality of rules associated with the plurality of membership functions includes rules for at least a digging segment, a swing loaded segment, a dumping segment, and a swing empty segment.

15. The control system of claim 14, wherein the rule for the digging segment is defined as having the boom linkage angle as a first boom angle, the boom movement status as a first boom movement status, the stick angle as a first stick angle, the stick movement status as a first stick movement status, and the body swing status as a first body swing status.

16. The control system of claim 14, wherein the rule for the swing loaded segment is defined as having the boom linkage angle as a second boom angle, the boom movement status as a second boom movement status, the stick angle as a second stick angle, the stick movement status as a second stick movement status, and the body swing status as a second body swing status.

17. The control system of claim 14, wherein the rule for the dumping segment is defined as having the boom linkage angle as a third boom angle, the boom movement status as a third boom movement status, the stick angle as a third stick angle, the stick movement status as the first stick movement status, and the body swing status as the first body swing status.

18. The control system of claim 14, wherein the rule for the swing empty segment is defined as having the boom linkage angle as the first boom angle, the boom movement status as the first boom movement status, the stick angle as the second stick angle, the stick movement status as the second stick movement status, and the body swing status as the first body swing status.

19. A machine comprising:
a plurality of sensors coupled to a plurality of parts on the machine, the plurality of sensors configured to generate data indicative of motion of the plurality of parts;
a display system; and
a controller communicably coupled to the plurality of sensors, and the display system, the controller configured to:
receive data indicative of the motion of the plurality of parts of the machine from the plurality of sensors;
determine a segment of a work cycle being currently performed by the machine based on the data received by the plurality of sensors, a plurality of membership functions, and a plurality of rules associated with the plurality of membership functions;
generate productivity data of the machine based on the determined segment of the work cycle; and
display the productivity data of the machine on the display system of the machine.

20. The machine of claim 19, wherein the plurality of sensors comprise Inertial Measuring Unit (IMU) sensors.
